(19) United States
(12) Patent Application Publication
(10) Pub. No.: US 2007/0051244 A1
(43) Pub. Date: Mar. 8, 2007

(54) DOOR MOUNT AIR CONDITIONING APPARATUS

(76) Inventor: Chien-Chung Chang, Taipei (TW)

Correspondence Address: BANNER & WITCOFF, 1001 G STREET N W, SUITE 1100, WASHINGTON, DC, 20001, US

(21) Appl. No.: 11/469,638

(22) Filed: Sep. 1, 2006

(30) Foreign Application Priority Data
Sep. 6, 2005 (TW) 094130513

(51) Int. Cl. B01D 46/00

(52) U.S. Cl. 96/226

(57) ABSTRACT

A door mount air conditioning apparatus includes: a casing defining an accommodating space; a fan unit mounted in the accommodating space; a control panel mounted on the casing and connected electrically to the fan unit; a flow-guiding mechanism including an air-collecting conduit connected to and extending downwardly from the casing and having a lower open end, and a ground abutting unit connected to and extending downwardly from the lower open end of the air-collecting conduit; and a bracket unit including a supporting frame adapted to be secured to a door panel. The casing and the air-collecting conduit are detachably mounted on the supporting frame.

### CROSS-REFERENCE TO RELATED APPLICATION

This application claims the priority of Taiwanese Application No. 094130513, filed on Sep. 6, 2005.

### BACKGROUND OF THE INVENTION

1. Field of the Invention

This invention relates to a door mount air conditioning apparatus, more particularly to a door mount air conditioning apparatus adapted to be mounted on a door panel and including a fan unit for drawing fresh air into a room.

2. Description of the Related Art

Conventional air conditioning apparatuses are normally fitted into a hole in a wall of a room for drawing fresh air into the room or use a blower and pipe lines for transporting fresh air into a room. However, installation of the conventional air conditioning apparatus in a closed room or a room without windows or holes in a wall is relatively complicated and expensive.

### SUMMARY OF THE INVENTION

Therefore, the object of the present invention is to provide a door mount air conditioning apparatus that can overcome the aforesaid drawback of the prior art.

According to this invention, there is provided a door mount air conditioning apparatus that comprises: a casing defining an accommodating space therein and top and bottom openings in fluid communication with the accommodating space, the casing having a top open end defining the top opening that serves as an air outlet, and a bottom open end defining the bottom opening; a fan unit mounted in the accommodating space below the top opening in the casing for drawing air thereunder and discharging air through the air outlet; a control panel mounted on the casing and connected electrically to the fan unit for actuating the fan unit; a flow-guiding mechanism including an air-collecting conduit connected to and extending downwardly from the bottom open end of the casing and having a lower open end, and a ground abutting unit connected to and extending downwardly from the lower open end of the air-collecting conduit and defining a bottom opening that serves as an air inlet and that is in fluid communication with the air outlet through the air-collecting conduit and the accommodating space in the casing; and a bracket unit including a supporting frame adapted to be secured to a door panel. The casing and the air-collecting conduit are detachably mounted on the supporting frame.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic view of the first preferred embodiment of a door mount air conditioning apparatus for mounting to a door panel according to this invention;

FIG. 2 is an exploded schematic view of the first preferred embodiment;

FIG. 3 is a partly sectional view of the first preferred embodiment to illustrate a state where a ground abutting unit is disposed at a lower position to abut against the ground level when the door panel is disposed at a closed position;

FIG. 4 is an exploded schematic view of the ground abutting unit of the first preferred embodiment;

FIG. 5 is a fragmentary perspective view to illustrate how an flexible strip is connected to a hinge of the first preferred embodiment;

FIG. 6 is a schematic top view of the first preferred embodiment to illustrate the state where the door panel is disposed at the closed position;

FIG. 7 is a fragmentary schematic view to illustrate the state where the door panel is disposed at the closed position and where a toothed member of the first preferred embodiment is disposed at a first position;

FIG. 8 is a schematic top view to illustrate how the toothed member of the first preferred embodiment is moved by the flexible strip upon opening of the door panel;

FIG. 9 is a fragmentary schematic view to illustrate another state where the toothed member of the first preferred embodiment is disposed at a second position when the door panel is disposed at an opened position;

FIG. 10 is a sectional side view to illustrate the state where the door panel is disposed at the opened position and where the ground abutting unit is disposed at an upper position; and

FIG. 11 is an exploded schematic view of the second preferred embodiment of the door mount air conditioning apparatus according to this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

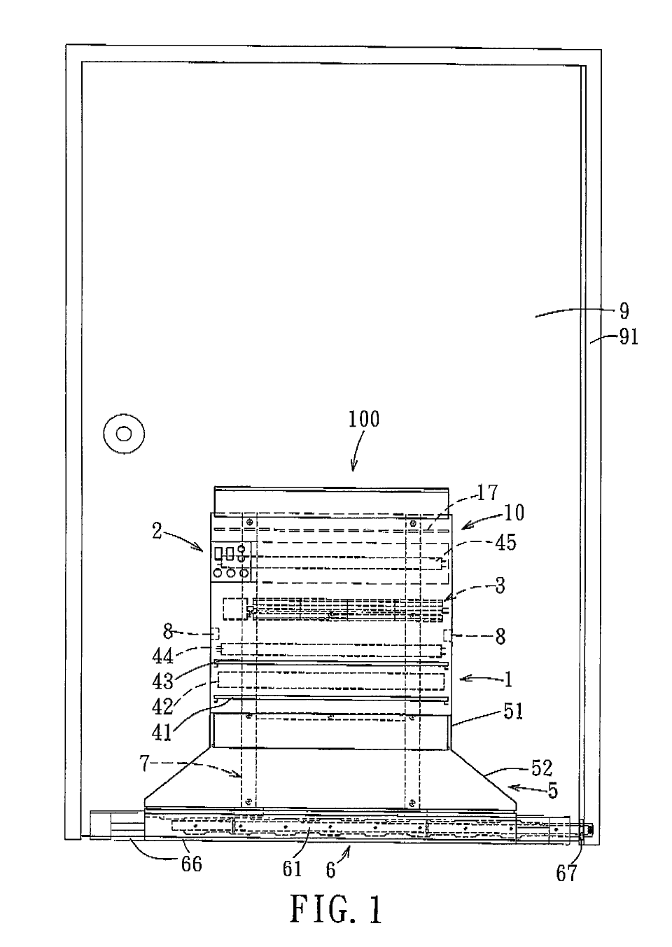

FIGS. 1 to 6 illustrate the first preferred embodiment of a door mount air conditioning apparatus 100 according to this invention. The door mount air conditioning apparatus 100 includes: a casing 10 defining an accommodating space 101 therein and top and bottom openings 14, 13 in fluid communication with the accommodating space 101, the casing 10 having a top open end 11 defining the top opening 14 that serves as an air outlet 14′, and a bottom open end 12 defining the bottom opening 13; a fan unit 3 mounted in the accommodating space 101 below the top opening 14 in the casing 10 for drawing air thereunder and discharging air through the air outlet 14′; a control panel 2 mounted on the casing 10 and connected electrically to the fan unit 3 for actuating the fan unit 3; a flow-guiding mechanism including an air-collecting conduit 5 connected to and extending downwardly from the bottom open end 12 of the casing 10 and having a lower open end 53, and a ground abutting unit 6 connected to and extending downwardly from the lower open end 53 of the air-collecting conduit 5 and defining a bottom opening 60 that serves as an air inlet 60′ and that is in fluid communication with the air outlet 14′ through the air-collecting conduit 5 and the accommodating space 101 in the casing 10; and a bracket unit 7 including a supporting frame 71 adapted to be secured to a door panel 9. The casing 10 and the air-collecting conduit 5 are detachably mounted on the supporting frame 71.

In this embodiment, the casing 10 and the air-collecting conduit 5 are slidably mounted on the supporting frame 71. The bracket unit 7 further includes a cushioning pad 73 attached to the supporting frame 71. A coupling unit includes a pair of parallel rails 72, each of which is secured to the casing 10 and the air-collecting conduit 5 and each of which extends from the lower open end 53 of the air-collecting conduit 5 to the top open end 11 of the casing 10, and a pair of parallel tracks 75, each of which is secured to abeam 712 of the supporting frame 71 and each of which defines a guiding groove 76. Each of the rails 72 engages slidably the guiding groove 76 in a respective one of the tracks 75.

The air-collecting conduit 5 includes a neck portion 51 extending downwardly from the bottom open end 12 of the casing 10, and a funnel portion 52 enlarged in cross-section from the neck portion 51.

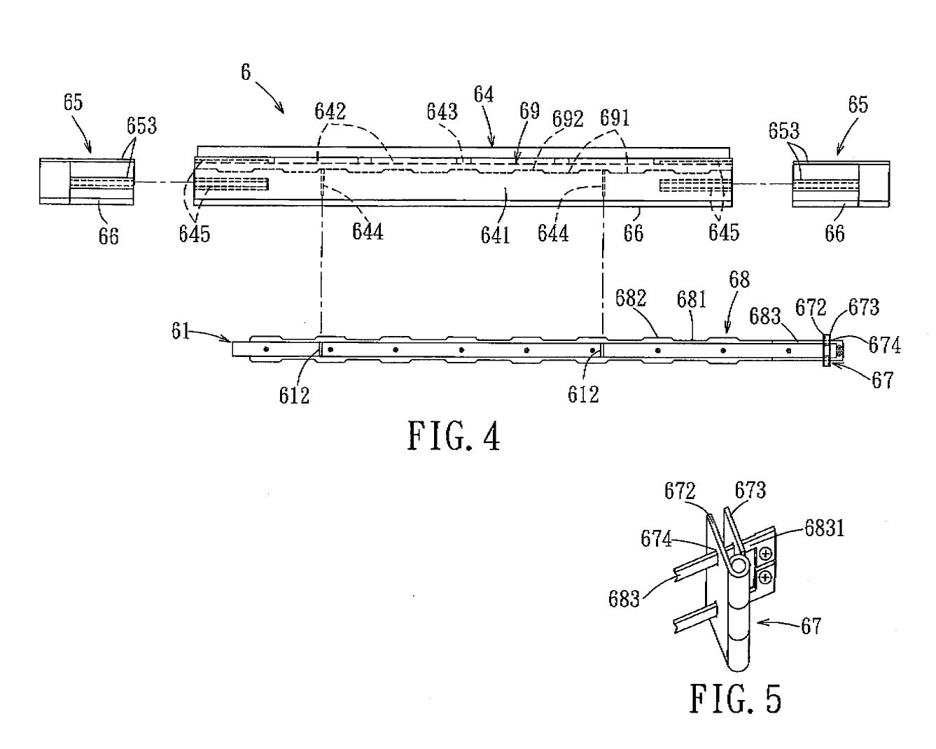

The ground abutting unit 6 includes an elongate mounting plate 61 that is adapted to be secured to the door panel 9 and that is provided with a pair of hollow posts 612 (see FIG. 4) and an L-shaped main frame 64 that defines the air inlet 60′ and that has an upper wall 643 formed with a pair of inserting pins 644 which extend downwardly therefrom and which are respectively inserted into the hollow posts 612 of the elongate mounting plate 61 so as to permit movement of the L-shaped main frame 64 relative to the elongate mounting plate 61 in a vertical direction. The L-shaped main frame 64 further has a front wall 641 that extends downwardly from the upper wall 643 and that has a bottom end provided with an elastic member 66 adapted to contact sealingly the ground level 92. The upper wall 643 of the L-shaped main frame 64 is formed with a plurality of through-holes 642 in fluid communication with the air inlet 60′ and the air-collecting conduit 5. The L-shaped main frame 64 has two opposite ends provided with tracks 645. The ground abutting unit 6 further includes a pair of side frames 65 having rails 653 and connected telescopically and respectively to the two opposite ends of the main frame 64 by rail-and-track engagement between each track 645 and a respective rail 653 such that an overall length of the L-shaped main frame 64 and the side frames 65 is adjustable. Each of the side frames 65 has a bottom end provided with the elastic member 66.

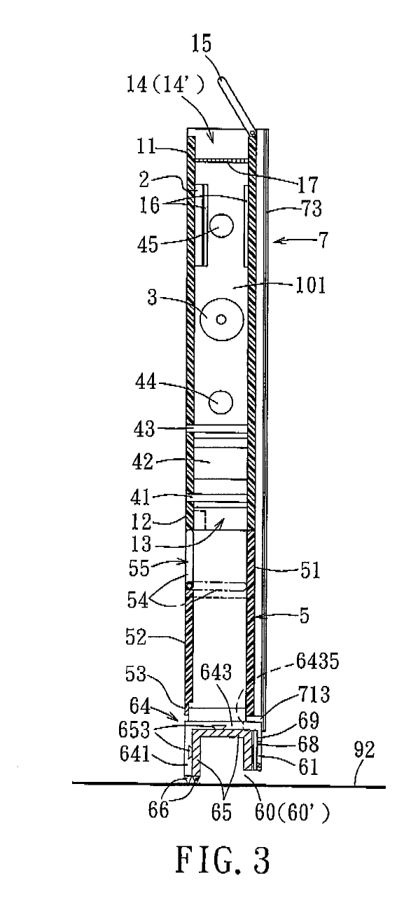

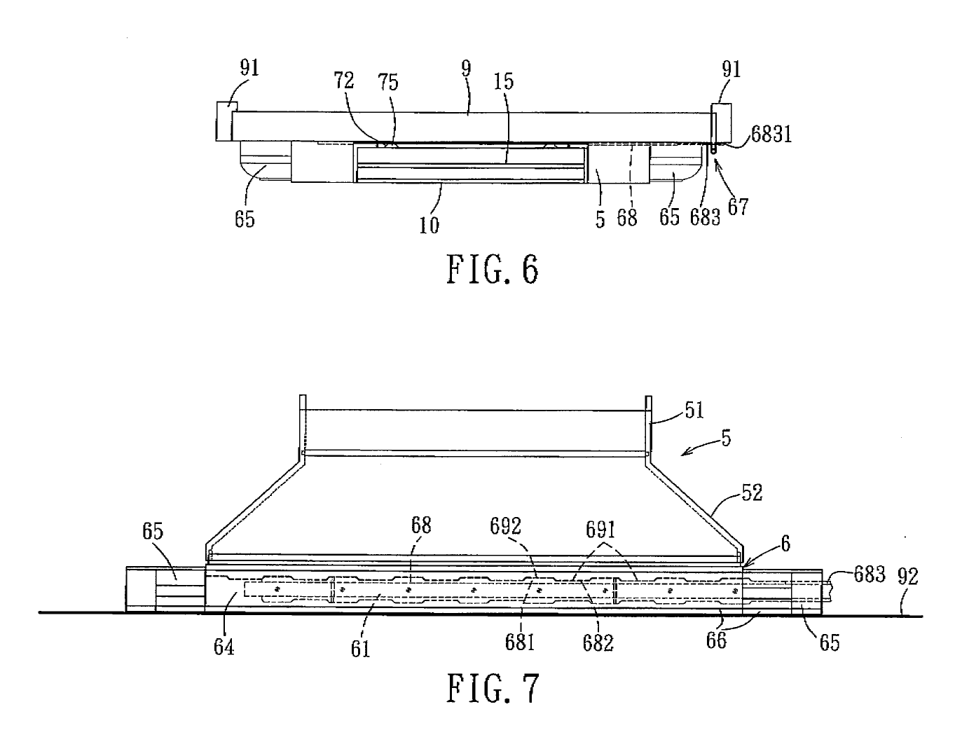

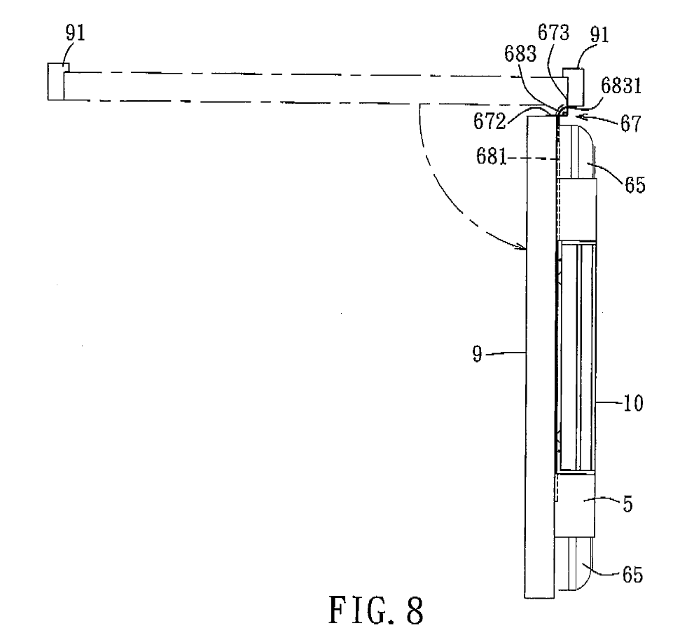

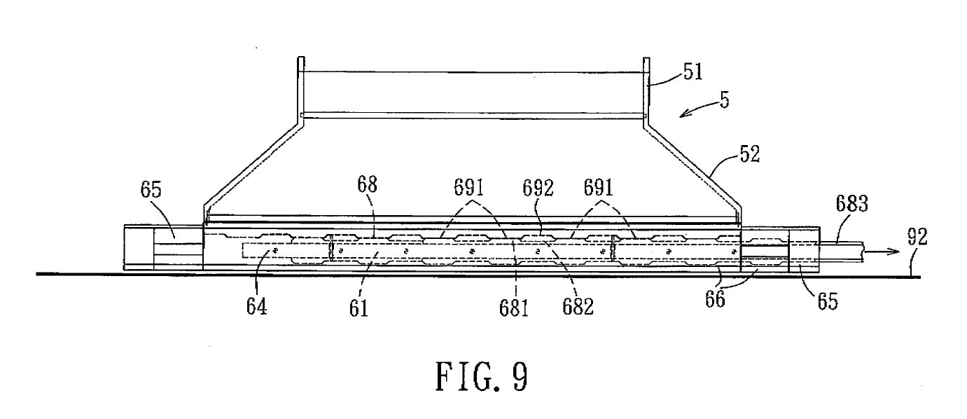

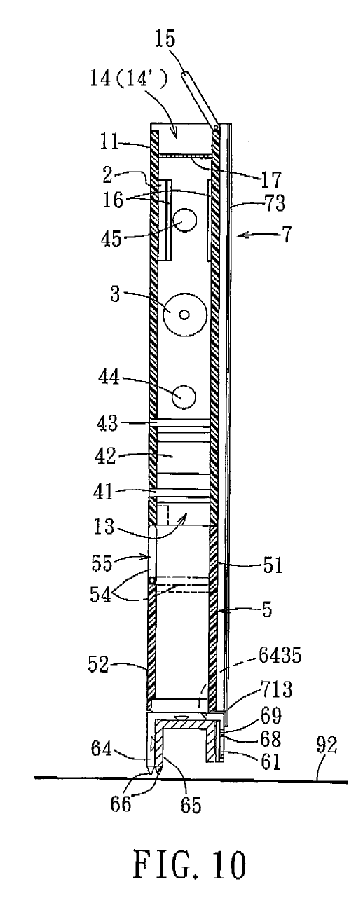

The door mount air conditioning apparatus 100 is further provided with a lifting mechanism including a hinge 67 (see FIG. 5) having a pair of leaves 672, 673 that are adapted to be respectively secured to the door panel 9 and a door frame 91 (see FIG. 8) and that are formed with through-holes 674, a first toothed member 68 mounted movably on the elongate mounting plate 61, movable in a horizontal direction from a first position (see FIG. 7) to a second position (see FIG. 9), and having at least one first protrusion 681 and at least one first recess 682 which is aligned with the first protrusion 681 in the horizontal direction, and a second toothed member 69 provided on and extending downwardly from the upper wall 643 of the L-shaped main frame 64, aligned with the first toothed member 68 in the vertical direction, and having at least one second protrusion 691 and at least one second recess 692 which is aligned with the second protrusion 691 in the horizontal direction. The second toothed member 69 is in sliding contact with the first toothed member 68 in such a manner that movement of the first toothed member 68 from the first position to the second position results in movement of the second toothed member 69 in the vertical direction from a lower position (see FIG. 3), in which the first and second protrusions 681, 691 are respectively received in the second and first recesses 692, 682 (see FIG. 7), to an upper position (see FIG. 10), in which the first and second protrusions 681, 691 are stacked one on the top of the other in the vertical direction (see FIG. 9). The lifting mechanism further includes an flexible strip 683 connected to the first toothed member 68 and having an end portion 6831 which extends through the through-holes 674 in the leaves 672, 673 of the hinge 67 (see FIG. 5) and which is fastened to the door frame 91 (see FIG. 8) so that movement of the door panel 9 from a closed position (see FIG. 6) to an opened position (see FIG. 8) results in bending of the flexible strip 683, which, in turn, results in movement of the first toothed member 68 from the first position to the second position by pulling action of the flexible strip 683, and which, in turn, results in movement of the second toothed member 69 together with the L-shaped main frame 64 from the lower position to the upper position. Note that the elastic members 66 are lifted above the ground level 92 (see FIG. 10) during movement of the L-shaped main frame 64 from the lower position to the upper position, thereby preventing undesired friction between the elastic members 66 and the ground level 92 during opening and closing of the door panel 9. Each of the first and second protrusions 681, 691 is trapezoid in shape.

The casing 10 is provided with a guiding plate 15 (see FIG. 3) that is pivoted to the top open end 11 of the casing 10 and that is angularly adjustable relative to the casing 10 so as to guide air flow direction discharged from the air outlet 14′.

The neck portion 51 of the air-collecting conduit 5 has a front opening 55 in fluid communication with the accommodating space 101 in the casing 10, and is provided with a front cover 54 that is pivoted to a periphery of the front opening 55 so as to be rotatable relative to the neck portion 51 between a first angular position, in which the front cover 54 covers the front opening 55, and a second angular position, in which the front cover 54 covers a bottom opening of the neck portion 51, thereby preventing air from being drawn through the air inlet 60′ into the air-collecting conduit 5 and permitting air circulation through the front opening 55, the accommodating space 101 and the air outlet 14′.

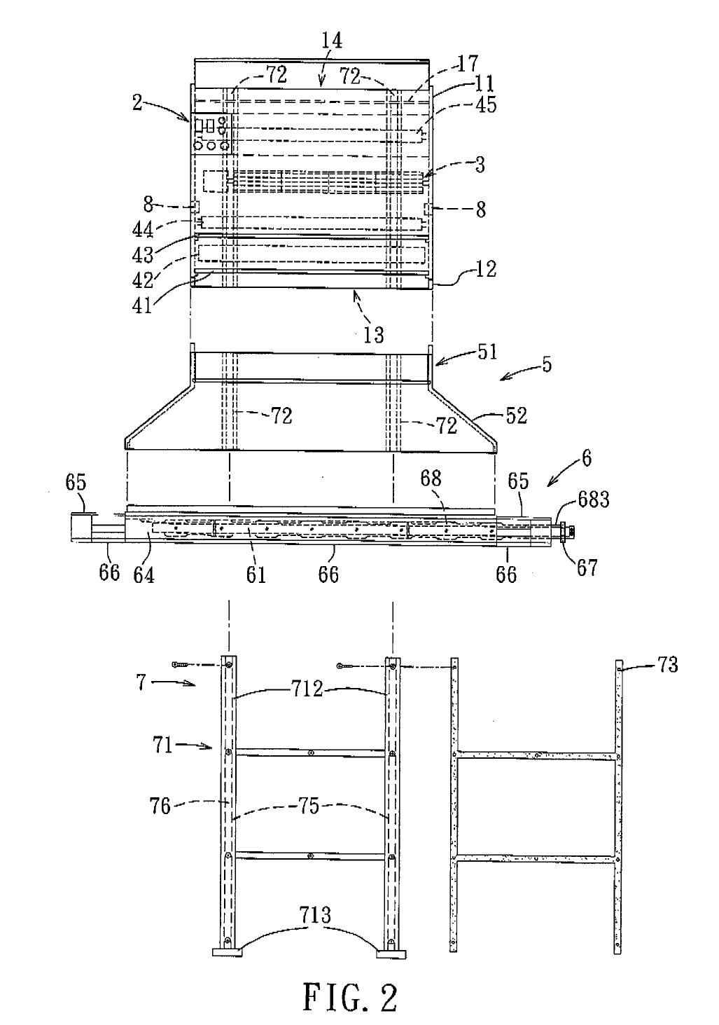

The supporting frame 71 has a bottom end provided with a pair of stoppers 713 (see FIG. 2). The lower open end 53 of the air-collecting conduit 5 is seated on the stoppers 713 of the supporting frame 71. A pair of notches 6435 (see FIGS. 3 and 10) are formed in the upper wall 643 of the L-shaped main frame 64 and are respectively aligned with the stoppers 713 for permitting movement of the L-shaped main frame 64 in the vertical direction.

The door mount air conditioning apparatus 100 may optionally further include a screen 17, filters 41, 43, a heater 45 disposed between a pair of thermal insulators 16, a negative ion generator 42, and a germ-killing lamp 44 which are mounted in the accommodating space 101 in the casing 10. A power connector 8 is provided on the casing 10 for connecting to a power supply (not shown).

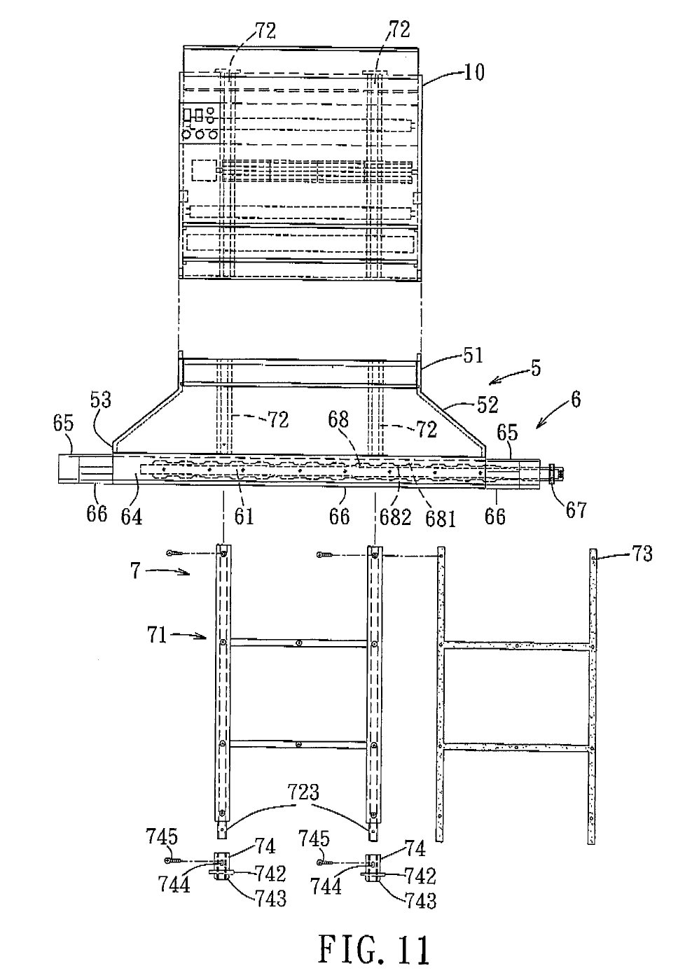

FIG. 11 illustrates the second preferred embodiment of the door mount air conditioning apparatus according to this invention. The second preferred embodiment differs from the previous embodiment in the structure of the lifting mechanism for lifting the L-shaped main frame 64. In this embodiment, the supporting frame 71 has a pair of end protrusions 723 provided with a pair of sleeves 74 sleeved movably and respectively thereon. Each of the sleeves 74 is formed with a stopper 742 and a protrusion 743 extending downwardly from the stopper 742. The lower open end 53 of the air-collecting conduit 5 is seated on the stoppers 742 of the sleeves 74. The air-collecting conduit 5 is movably connected to the bottom open end 12 of the casing 10. The first toothed member 68 is aligned with the sleeves 74 in the vertical direction and is in sliding contact with the protrusions 743 of the sleeves 74 in such a manner that horizontal movement of the first toothed member 68 from the first position to the second position results in movement of the sleeves 74 together with the air-collecting conduit 5 and the L-shaped main frame 64 in the vertical direction from a lower position (not shown), in which the protrusions 743 of the sleeves 74 are respectively received in the first recesses 682, to an upper position (not shown), in which each of the protrusions 681 of the first toothed member 68 is stacked on the protrusion 743 of a respective one of the sleeves 74 in the vertical direction. In this embodiment, the second toothed member 69 of the first preferred embodiment is dispensed with. Each of the sleeves 74 is further formed with a slot 744 extending in the vertical direction for extension of a screw 745 therethrough and for permitting mounting of the sleeves 74 on the end protrusions 723 of the supporting frame 71.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A door mount air conditioning apparatus comprising:
a casing defining an accommodating space therein and top and bottom openings in fluid communication with said accommodating space, said casing having a top open end defining said top opening that serves as an air outlet, and a bottom open end defining said bottom opening;
a fan unit mounted in said accommodating space below said top opening in said casing for drawing air thereunder and discharging air through said air outlet;
a control panel mounted on said casing and connected electrically to said fan unit for actuating said fan unit;
a flow-guiding mechanism including an air-collecting conduit connected to and extending downwardly from said bottom open end of said casing and having a lower open end, and a ground abutting unit connected to and extending downwardly from said lower open end of said air-collecting conduit and defining a bottom opening that serves as an air inlet and that is in fluid communication with said air outlet through said air-collecting conduit and said accommodating space in said casing; and
a bracket unit including a supporting frame adapted to be secured to a door panel;
wherein said casing and said air-collecting conduit are detachably mounted on said supporting frame.

2. The door mount air conditioning apparatus of claim 1, wherein said casing and said air-collecting conduit are slidably mounted on said supporting frame.

3. The door mount air conditioning apparatus of claim 2, wherein said bracket unit further includes a cushioning pad attached to said supporting frame.

4. The door mount air conditioning apparatus of claim 2, further comprising a coupling unit including a pair of parallel rails, each of which is secured to said casing and said air-collecting conduit and each of which extends from said lower open end of said air-collecting conduit to said top open end of said casing, and a pair of parallel tracks, each of which is secured to said supporting frame and each of which defines a guiding groove, each of said rails engaging slidably said guiding groove in a respective one of said tracks.

5. The door mount air conditioning apparatus of claim 4, wherein said air-collecting conduit includes a neck portion extending downwardly from said bottom open end of said casing, and a funnel portion enlarged in cross-section from said neck portion.

6. The door mount air conditioning apparatus of claim 1, wherein said ground abutting unit includes an elongate mounting plate that is adapted to be secured to the door panel and that is provided with a pair of hollow posts, and an L-shaped main frame that defines said air inlet and that has an upper wall formed with a pair of inserting pins which extend downwardly therefrom and which are respectively inserted into said hollow posts so as to permit movement of said L-shaped main frame relative to said elongate mounting plate in a vertical direction, said L-shaped main frame further having a front wall that extends downwardly from said upper wall and that has a bottom end provided with an elastic member adapted to contact sealingly the ground level.

7. The door mount air conditioning apparatus of claim 6, wherein said upper wall of said L-shaped main frame is formed with a plurality of through-holes in fluid communication with said air inlet and said air-collecting conduit.

8. The door mount air conditioning apparatus of claim 6, wherein said L-shaped main frame has two opposite ends, said ground abutting unit further including a pair of side frames connected telescopically and respectively to said two opposite ends of said main frame such that an overall length of said L-shaped main frame and said side frames is adjustable.

9. The door mount air conditioning apparatus of claim 8, wherein said side frames are slidably connected to said L-shaped main frame in a rail-and-track engaging manner.

10. The door mount air conditioning apparatus of claim 6, further comprising a lifting mechanism including a hinge having a pair of leaves that are adapted to be respectively secured to the door panel and a door frame and that are formed with through-holes, a first toothed member mounted movably on said elongate mounting plate, movable in a horizontal direction from a first position to a second position, and having at least one first protrusion and at least one first recess which is aligned with said first protrusion in said horizontal direction, and a second toothed member provided on said L-shaped main frame, aligned with said first toothed member in said vertical direction, and having at least one second protrusion and at least one second recess which is aligned with said second protrusion in said horizontal direction, said second toothed member being in sliding contact with said first toothed member in such a manner that movement of said first toothed member from said first position to said second position results in movement of said second toothed member in said vertical direction from a lower position, in which said first and second protrusions are respectively received in said second and first recesses, to an upper position, in which said first and second protrusions are stacked one on top of the other in said vertical direction, said lifting mechanism further including an flexible strip connected to said first toothed member and having an end portion which extends through said through-holes in said leaves of said hinge and which is fastened so that movement of the door panel from a closed position to an opened position results in bending of said flexible strip, which, in turn, results in movement of said first toothed member from said first position to said second position by pulling action of said flexible strip, and which, in turn, results in movement of said second toothed member together with said L-shaped main frame from said lower position to said upper position.

11. The door mount air conditioning apparatus of claim 10, wherein each of said first and second protrusions is trapezoid in shape.

12. The door mount air conditioning apparatus of claim 1, wherein said casing is provided with a guiding plate that is pivoted to said top open end of said casing and that is angularly adjustable relative to said casing so as to guide air flow direction discharged from said air outlet.

13. The door mount air conditioning apparatus of claim 5, wherein said neck portion of said air-collecting conduit has a front opening in fluid communication with said accommodating space in said casing, and is provided with a front cover that is pivoted to a periphery of said front opening for covering said front opening.

14. The door mount air conditioning apparatus of claim 1, further comprising at least one filter, a heater, a negative ion generator, and a germ-killing lamp which are mounted in said accommodating space in said casing.

15. The door mount air conditioning apparatus of claim 1, wherein said supporting frame has a bottom end provided with a pair of stoppers, said lower open end of said air-collecting conduit being seated on said stoppers of said supporting frame.

16. The door mount air conditioning apparatus of claim 6, wherein said supporting frame has a pair of end protrusions provided with a pair of sleeves sleeved movably and respectively thereon, each of said sleeves being formed with a stopper and a protrusion extending downwardly from said stopper, said lower open end of said air-collecting conduit being seated on said stoppers of said sleeves, said air-collecting conduit being movably connected to said bottom open end of said casing, said door mount air conditioning apparatus further comprising a lifting mechanism including a hinge having a pair of leaves that are adapted to be respectively secured to the door panel and a door frame and that are formed with through-holes, and a toothed member mounted movably on said elongate mounting plate, aligned with said sleeves in a vertical direction, movable in a horizontal direction from a first position to a second position, and having a pair of protrusions and a pair of recesses which are aligned with said protrusions of said toothed member in said horizontal direction, said toothed member being in sliding contact with said protrusions of said sleeves in such a manner that movement of said toothed member from said first position to said second position results in movement of said sleeves in said vertical direction from a lower position, in which said protrusions of said sleeves are respectively received in said recesses, to an upper position, in which each of said protrusions of said toothed member is stacked on said protrusion of a respective one of said sleeves in said vertical direction, said lifting mechanism further including an flexible strip connected to said toothed member and having an end portion which extends through said through-holes in said leaves of said hinge and which is fastened so that movement of the door panel from a closed position to an opened position results in bending of said flexible strip, which, in turn, results in movement of said toothed member from said first position to said second position by pulling action of said flexible strip, and which, in turn, results in movement of said sleeves together with said air-collecting conduit and said L-shaped main frame from said lower position to said upper position.
